(19) United States
(12) Patent Application Publication
(10) Pub. No.: US 2026/0238072 A1
(43) Pub. Date: Aug. 13, 2026

(54) END COIL COOLING SYSTEM FOR MOTOR

(71) Applicant: HYUNDAI MOBIS CO., LTD., Seoul (KR)

(72) Inventor: Dae Wook KIM, Yongin-si (KR)

(73) Assignee: HYUNDAI MOBIS CO., LTD., Seoul (KR)

(21) Appl. No.: 19/454,555

(22) Filed: Jan. 21, 2026

(30) Foreign Application Priority Data
Feb. 10, 2025 (KR) 10-2025-0016564

(51) Int. Cl. H02K 5/20; H02K 1/16; H02K 9/19

(52) U.S. Cl. CPC H02K 5/203; H02K 1/16; H02K 9/19

(57) ABSTRACT

The present invention relates to a cooling system applied to a motor for cooling components of the motor, and more particularly, to an end coil cooling system for a motor configured to improve the cooling performance of end coils among the coils wound on a stator of the motor.

### CROSS REFERENCE TO RELATED APPLICATION

The present application claims priority to Korean Patent Application No. 10-2025-0016564, filed Feb. 10, 2025, the entire contents of which is incorporated herein for all purposes by this reference.

### BACKGROUND OF THE INVENTION

### Field of the Invention

The present invention relates to a cooling system applied to a motor for cooling components of the motor, and more particularly, to an end coil cooling system for a motor configured to improve the cooling performance of end coils among the coils wound on a stator of the motor.

### Description of the Related Art

A motor for driving electrified vehicles such as electric vehicles includes a stator (stator core). The stator generates a magnetic field using electrical energy supplied from the outside, thereby enabling rotation of a rotor. In recent years, in order to achieve high performance, there has been a trend toward using high voltage and high output, and coils that receive high electrical energy generate a significant amount of heat. Since cooling the heat generated in the coils has a significant impact on motor performance, it is important to cool the motor heat efficiently.

Motor cooling methods generally include water cooling, oil cooling, and air cooling, with oil cooling being widely used for its advantages of enabling effective cooling by directly bringing oil into contact with the heat source, utilizing vehicle oils such as engine oil or reduction gear oil, and lubricating internal motor components using the cooling oil.

The flow of cooling fluid in a typical cooling method begins with cooling oil pumped through a filter and a heat exchanger for cooling the cooling oil, supplied to a main flow path, distributed in parallel to the bearings, O-shaped pipes, stator, and end coil cooling, sprayed at atmospheric pressure onto the internal motor components, collected in a sump at the bottom of the motor housing, and then suctioned by the pump for circulation. In particular, for cooling end coils, methods such as supplying oil through a straight pipe or an O-shaped pipe for spraying, spraying oil from the core, and using a deflector method have been employed. By using such direct oil injection methods, the temperature of the stator and end coils can be lowered.

The aforementioned O-shaped pipe is a configuration for cooling the end coils arranged at both axial ends of the stator by spraying oil supplied to the inside onto the end coils. Specifically, the O-shaped pipe may be arranged on the radial inner side of the end coils to spray oil toward the inner diameter side of the end coils, or arranged on the radial outer side of the end coils to spray oil toward the outer diameter side of the end coils.

However, the O-shaped pipe has a high unit cost and occupies space inside the motor housing that accommodates the stator or rotor core, thereby reducing the space utilization of the motor.

Furthermore, when the O-shaped pipe is arranged on the radial inner side of the end coils to spray oil from the inner diameter side toward the outer diameter side of the end coils in order to reduce space occupation, the amount of oil delivered to the radial outer side of the end coils may be small, resulting in degraded cooling performance.

### SUMMARY OF THE INVENTION

The present invention has been conceived to solve the above problems, and it is an object of the present invention to provide a coil cooling system for a motor in which the end coils are cooled through a separate cooling flow path for end coil cooling, independently of core cooling.

It is another object of the present invention to provide a coil cooling system for a motor that replaces the conventional O-shaped pipe oil spray structure by forming a flow path through housing machining and spraying oil onto the end coils via an oil spray ring using steel or aluminum hot or cold press fitting.

It is still another object of the present invention to provide a coil cooling system for a motor in which the oil flow path is arranged on the radial outer side of the end coils to spray the oil toward the outer diameter side of the end coils.

In order to accomplish the above objects, an end coil cooling system for a motor, configured to cool axial one-side and opposite-side end coils of coils wound on a stator and disposed on a housing accommodating the stator and a rotor core, according to an embodiment of the present invention, includes a main flow path disposed along the axial direction of the housing and supplying an oil for cooling the end coils, and one or more supply flow paths disposed along the radial direction of the housing, the upstream end of each supply flow path being in fluidical communication with the main flow path, and the downstream end of each supply flow path penetrating the inner circumferential surface of the housing to supply the oil from the main flow path to the end coils.

In addition, end coil cooling system further includes a distribution flow path disposed along a circumferential direction of the housing, recessed radially inwardly, a bottom surface of the distribution flow path being in fluidical communication with the supply flow path to distribute the oil in the circumferential direction, and a spray ring sealing a radially inwardly open surface of the distribution flow path and having one or more spray holes disposed therein to spray the oil onto an outer diameter of the end coils.

In addition, the distribution flow path is disposed in the axial direction on the housing to spray the oil to spray the oil onto portions of the end coil where the coil is exposed.

In addition, the spray ring is coupled to the distribution flow path by hot pressing during a hot pressing process of the stator.

In addition, the spray holes are disposed as a plurality along the circumferential direction and are offset to a first side or a second side of the supply flow path in the circumferential direction, rather than being aligned with the supply flow path.

In addition, the distribution flow path has a width, a height, or both the width and the height that decrease with increasing distance from the supply flow path along the circumferential direction.

In addition, the supply flow path includes an end supply flow path adjacent to a crown coil disposed on one axial side of the end coils and a front supply flow path adjacent to a weld coil disposed on the opposite axial side.

In addition, the distribution flow path includes an end distribution flow path in fluidical communication with the end supply flow path and a front distribution flow path in fluidical communication with the front supply flow path, and the spray ring includes an end spray ring coupled to the end distribution flow path to spray the oil onto the crown coil and a front spray ring coupled to the front distribution flow path to spray the oil onto the weld coil.

In addition, with respect to the circumferential direction, a first distance between a spray hole disposed on one side of the supply flow path and the supply flow path and a second distance between a spray hole disposed on the opposite side of the supply flow path and the supply flow path are equal.

In addition, the plurality of spray holes have a spacing that decreases or a diameter that increases as the distance from the supply flow path along the circumferential direction increases.

### BRIEF DESCRIPTION OF THE DRAWINGS

FIG. 1 is a partially enlarged cross-sectional view of a motor illustrating the cooling system of the present invention;

FIG. 2 is a perspective view of the end side of the main housing of the present invention;

FIG. 3 is a partially enlarged perspective view of the main housing illustrating the distribution flow path of the present invention;

FIG. 4 is a perspective view of the end side of the main housing with a spray ring coupled in the cooling system of the present invention;

FIG. 5 is a perspective view of the spray ring of the present invention;

FIG. 6 is a perspective view of the end side of the main housing illustrating the end-side oil flow of the cooling system of the present invention;

FIG. 7 is a partially enlarged perspective view of the front side of the middle housing illustrating the distribution flow path formed in the cooling system of the present invention;

FIG. 8 is a partially enlarged perspective view of the front side of the middle housing with the spray ring coupled in the cooling system of the present invention;

FIG. 9 is a partially enlarged perspective view of the middle housing illustrating the oil flow of the cooling system of the present invention before and after coupling the spray ring; and

FIG. 10 is a plan view of the front side of the middle housing illustrating the front-side oil flow of the cooling system of the present invention.

### DETAILED DESCRIPTION OF THE INVENTION

In the following, the technical aspects of the present invention will be described in more detail with reference to the accompanying drawings. Prior to this, the terms and words used in the following specification and claims should not be construed in a limited sense to their usual or dictionary meanings but should be interpreted according to the meanings and concepts that conform to the technical ideas of the present invention, based on the principle that the inventor can appropriately define the terms to best describe their invention.

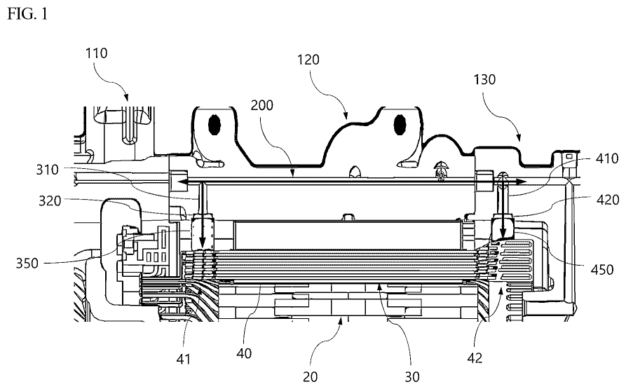

FIG. 1 is a partially enlarged cross-sectional view of a motor illustrating the cooling system 1000 of the present invention.

Before describing the cooling system 1000, the components of the motor to which the cooling system 1000 is applied will be briefly explained.

First, a rotor core 20 may be provided on the radial outer side of a drive shaft (not shown), and a stator 30 may be provided on the outer side of the rotor core 20. Coils 40 may be wound on the stator 30 along the axial direction, and on one axial side of the stator 30, one of the end coils, namely the crown coil 41, is disposed, while on the other axial side, the other end coil, namely the weld coil 42, is disposed. A reducer for reduction may be provided on the opposite axial side of the shaft.

Meanwhile, the motor includes a housing composed of an end cover 110, a main housing 120, a middle housing 130, and a reducer cover (not shown), which are sequentially coupled from one axial side to the other and accommodate the above components.

The main housing 120 accommodates the rotor core 20 and the stator 30, the end cover 110 is coupled to one open end of the main housing 120, and the middle housing 130 is coupled to the other open end of the main housing 120. In addition, the reducer is accommodated in the reducer cover and coupled to the other open end of the middle housing 130.

The end coil cooling system 1000 of the present invention may include an oil distribution flow path formed in the main housing 120 and the middle housing 130 and a spray ring coupled to the oil distribution flow path for spraying oil onto the end coils.

Hereinafter, the detailed configuration of the end coil cooling system 1000 described above will be explained with reference to the drawings.

The cooling system 1000 includes a main flow path 200 for supplying cooling oil, an end supply flow path 310 for supplying the oil from the main flow path 200 toward the crown coil 41, an end distribution flow path 320 for distributing the oil along the circumferential direction of the crown coil 41, and an end spray ring 350 for spraying the oil supplied to the end distribution flow path 320 onto the outer diameter of the crown coil 41.

In addition, the cooling system 1000 may include a front supply flow path 410 for supplying the oil from the main flow path 200 toward the weld coil 42, a front distribution flow path 420 for distributing the oil along the circumferential direction of the weld coil 42, and a front spray ring 450 for spraying the oil supplied to the front distribution flow path 420 onto the outer diameter of the weld coil 42.

The main flow path 200 is formed hollow along the axial direction of the end cover 110, the main housing 120, and the middle housing 130, and is configured to supply oil for end coil cooling to the interior. The main flow path 200 may include a plurality of paths along the circumferential direction.

The end supply flow path 310 is formed hollow along the radial direction of the main housing 120, with an upstream end communicating with the main flow path 200 and a downstream end penetrating the inner circumferential surface of the main housing 120. The downstream end of the end supply flow path 310 may be formed close to the crown coil 41. Therefore, the end supply flow path 310 may be formed on one axial side of the main housing 120 corresponding to the end side. The end supply flow path 310 may include a plurality of paths formed along the circumferential direction.

The front supply flow path 410 is formed hollow along the radial direction of the middle housing 130, with an upstream end communicating with the main flow path 200 and a downstream end penetrating the inner circumferential surface of the middle housing 130. The downstream end of the front supply flow path 410 may be formed close to the weld coil 42. Therefore, the front supply flow path 410 may be formed on one axial side of the middle housing 130 corresponding to the front side. The front supply flow path 410 may include a plurality of paths formed along the circumferential direction.

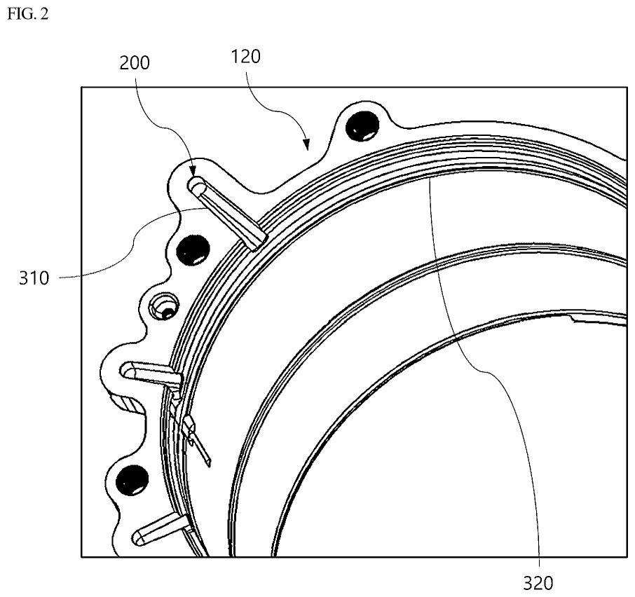

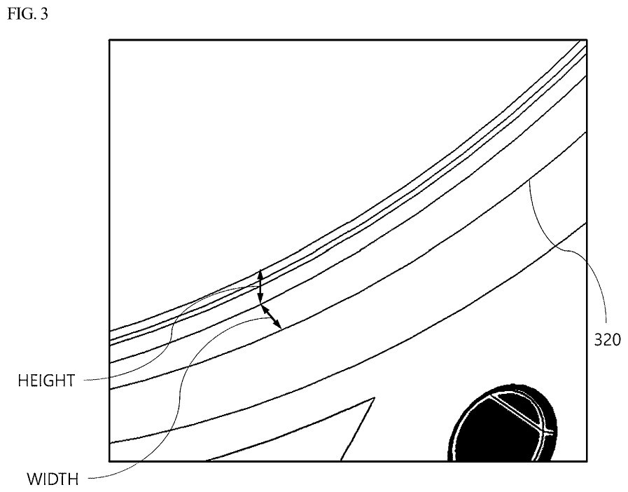

FIG. 2 is a perspective view illustrating the end side of the main housing 120, in which the end supply flow path 310 and the end distribution flow path 320 of the cooling system 1000 according to the present invention are formed, and FIG. 3 is a partially enlarged perspective view illustrating the main housing 120 including the end distribution flow path 320.

As shown, the end distribution flow path 320 is formed in the shape of an annular groove, specifically along the circumferential direction on the inner circumferential surface of the main housing 120, recessed radially outward from the inner circumferential surface. The end distribution flow path 320 communicates with the downstream end of one or more end supply flow paths 310 and is configured to receive oil through the end distribution flow path 320 and distribute it along the circumferential direction of the main housing 120.

The axial position of the end distribution flow path 320 may be adjusted according to the required cooling performance. That is, the axial position may be determined to spray oil onto portions of the crown coil 41 where the coil is exposed, rather than on portions covered with epoxy coating or insulating paper. However, when the exposed portion of the coil is significantly small, the end distribution flow path 320 may be positioned to spray onto the epoxy-coated portion.

In addition, the recessed height or thickness (width) of the end distribution flow path 320 may be increased or decreased according to the required cooling performance, and the configuration may be adjusted by varying the diameter or number of end spray holes 351, which will be described later.

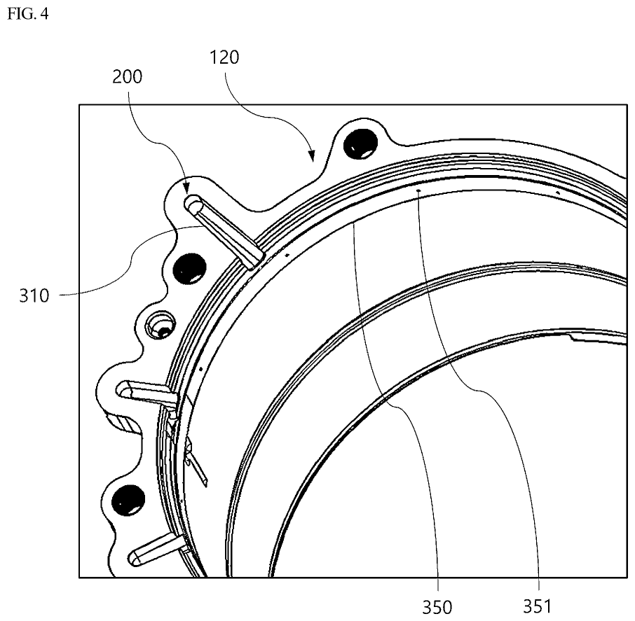

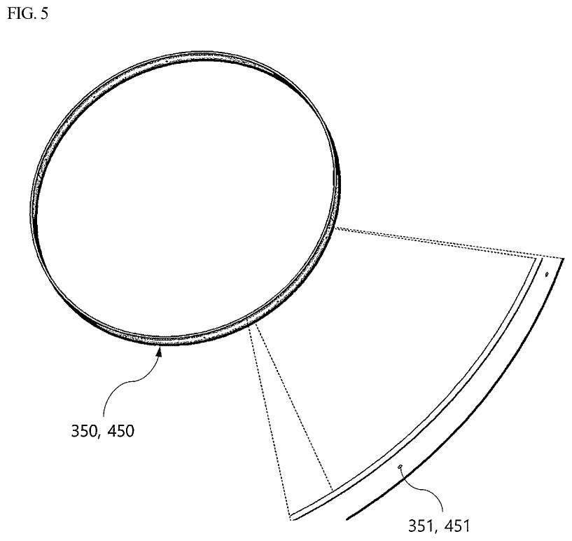

FIG. 4 is a perspective view of the end side of the main housing 120 with the end spray ring 350 of the cooling system 1000 of the present invention coupled thereto, and FIG. 5 is a perspective view of the end spray ring 350 of the present invention.

The end spray ring 350 is configured to seal the radially inner open surface of the end distribution flow path 320. The end spray ring 350 may be coupled to the main housing 120 by cold press fitting, hot press fitting, or other similar methods. In particular, the end spray ring 350 may be configured to be assembled together during the hot press fitting process of the main housing 120 of the stator, thereby shortening the manufacturing process. An end spray hole 351 is formed on the end spray ring 350 to spray the oil supplied to the end distribution flow path 320 onto the outer diameter of the crown coil 41. Accordingly, a plurality of end spray holes 351 may be formed along the circumferential direction at specific or arbitrary intervals.

The end spray holes 351 may not be aligned with the end supply flow path 310 in the circumferential direction, and may be arranged offset to one or the other side in the circumferential direction. This prevents most of the oil from being sprayed through spray holes aligned on the same line. Preferably, the offset distances of the end spray holes 351 on both sides of the end supply flow path 310 in the circumferential direction may be equal, such that oil is evenly sprayed through each end spray hole 351. In addition, the width and height of the end distribution flow path 320 may also be adjusted. That is, the width and height of the end distribution flow path 320 adjacent to the end supply flow path 310 may be increased, and the width and depth of the end distribution flow path 320 may decrease as the distance from the end supply flow path 310 increases, thereby improving distribution efficiency.

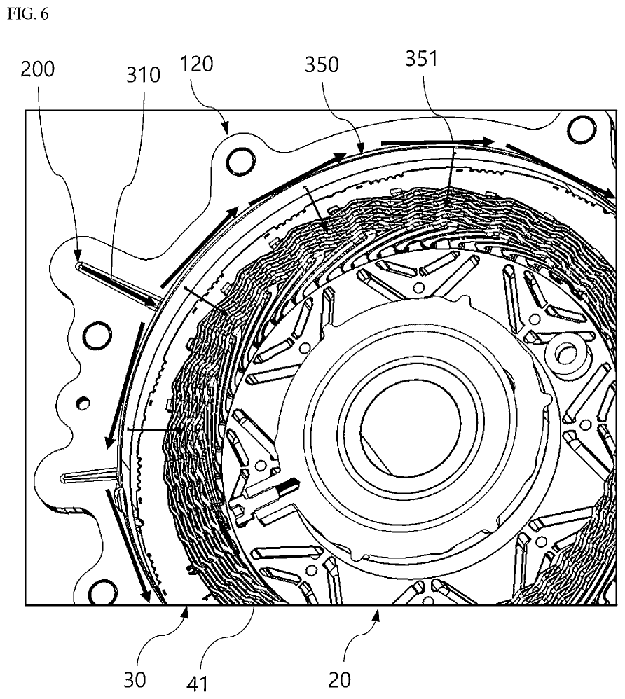

FIG. 6 is a perspective view of the end side of the main housing 120 of the motor, illustrating the oil flow sprayed onto the crown coil 41 arranged at the end side of the cooling system 1000 of the present invention.

As shown, the oil supplied to the main flow path 200 is delivered along the end supply flow path 310 to the inner circumferential surface of the main housing 120 adjacent to the crown coil 41, and is distributed along the circumferential direction of the inner circumferential surface of the main housing 120 adjacent to the outer diameter of the crown coil 41 through the end distribution flow path 320. The distributed oil is sprayed onto the outer diameter of the crown coil 41 through the end spray holes 351 of the end spray ring 350 covering the end distribution flow path 320, thereby cooling the heated crown coil 41.

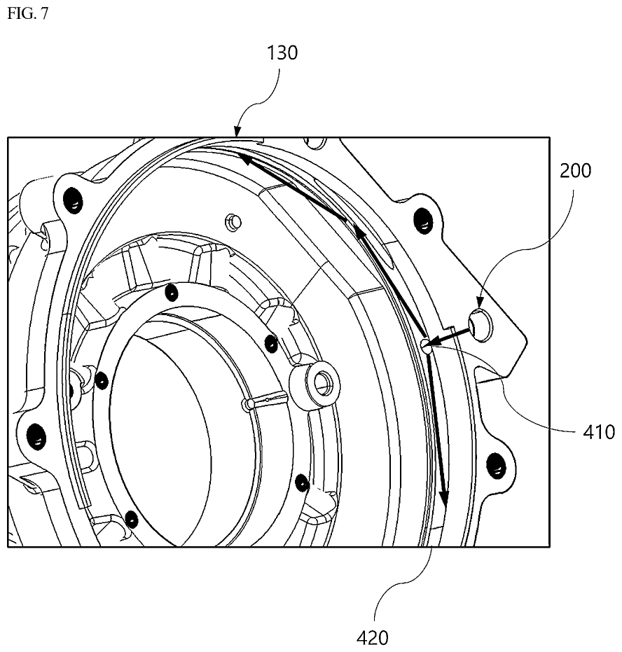

FIG. 7 is a partially enlarged perspective view of one axial end on the front side of the middle housing 130, illustrating the front distribution flow path 420 of the cooling system 1000 of the present invention.

The front distribution flow path 420 is formed in the shape of an annular groove, specifically along the circumferential direction on the inner circumferential surface of the middle housing 130, recessed radially outward from the inner circumferential surface. The front distribution flow path 420 communicates with the downstream end of one or more front supply flow paths 410 and is configured to receive oil through the front distribution flow path 420 and distribute it along the circumferential direction of the middle housing 130.

The axial position of the front distribution flow path 420 may be adjusted based on the required cooling performance. That is, the axial position may be determined to spray oil onto portions of the weld coil 42 where the coil is exposed, rather than onto portions covered with epoxy coating or insulating paper. However, when the exposed portion of the coil is significantly small, the end distribution flow path 320 may be positioned to spray onto the epoxy-coated portion.

In addition, the recessed height or thickness (width) of the front distribution flow path 420 may be increased or decreased according to the required cooling performance, and the configuration may be adjusted by varying the diameter or number of front spray holes 451, which will be described later.

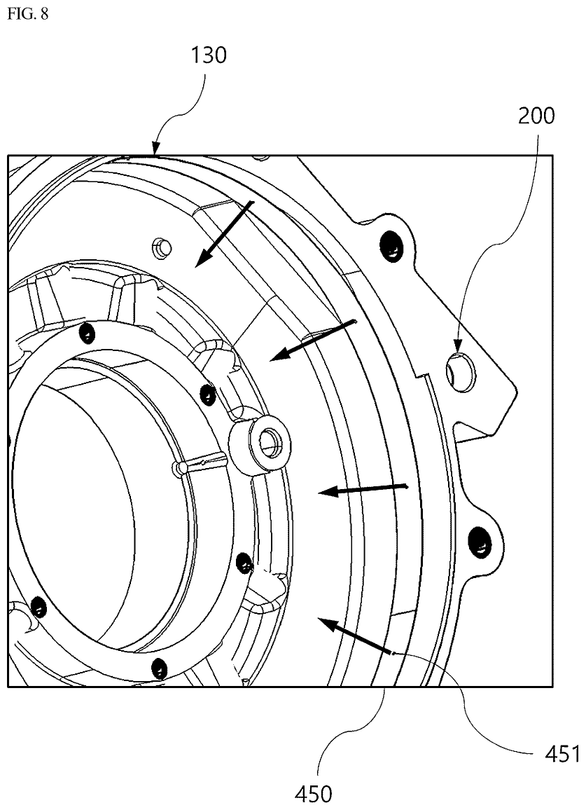

FIG. 8 is a partially enlarged perspective view of one axial end on the front side of the middle housing 130, illustrating the front spray ring 450 of the cooling system 1000 of the present invention coupled thereto.

The front spray ring 450 is configured to seal the radially inner open surface of the front distribution flow path 420. In particular, the front spray ring 450 may be installed together during the hot press fitting process of the stator in the middle housing 130, thereby shortening the manufacturing process. The front spray ring 450 includes front spray holes 451, through which the oil supplied to the front distribution flow path 420 is sprayed onto the outer diameter of the weld coil 42. Accordingly, a plurality of front spray holes 451 may be formed along the circumferential direction at specific or arbitrary intervals.

The front spray holes 451 are not aligned with the front supply flow path 410 in the circumferential direction, but may be offset to one or the other side in the circumferential direction. This prevents most of the oil from being sprayed through spray holes aligned on the same line. Preferably, the offset distances of the front spray holes 451 on both sides of the front supply flow path 410 in the circumferential direction may be equal, allowing oil to be evenly sprayed through each front spray hole 451. In addition, the width and height of the front distribution flow path 420 may also be adjusted. That is, the width and height of the front distribution flow path 420 adjacent to the front supply flow path 410 may be increased, and the width and height may gradually decrease with increasing distance from the front supply flow path 410 to enhance distribution efficiency.

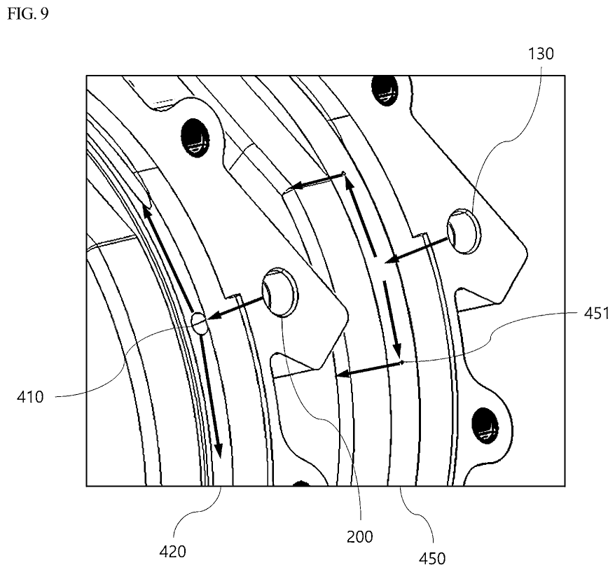

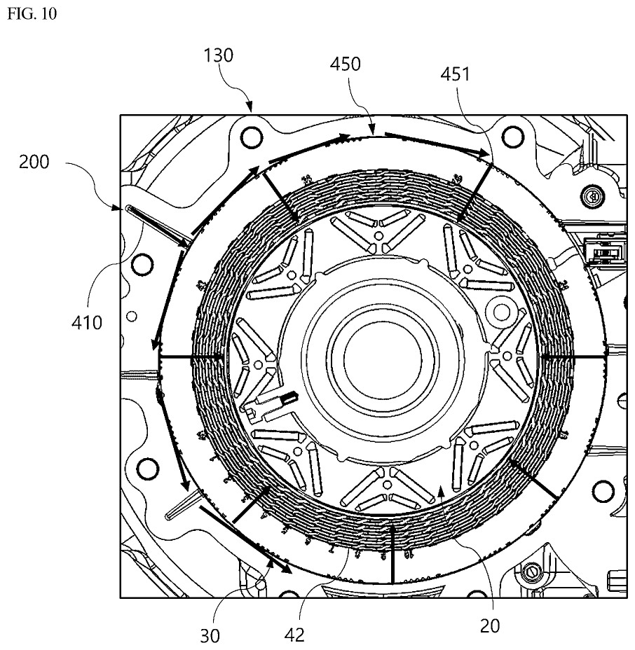

FIG. 9 is a partially enlarged perspective view of the middle housing 130 showing the oil flow sprayed onto the weld coil 42 on the front side of the cooling system 1000 of the present invention, both before and after coupling the spray ring, and FIG. 10 is a plan view of the front side of the middle housing 130 showing the oil flow sprayed onto the weld coil 42 on the front side of the cooling system 1000 of the present invention.

As illustrated, the oil supplied to the main flow path 200 is delivered along the front supply flow path 410 to the inner circumferential surface of the middle housing 130 adjacent to the weld coil 42 and is distributed along the circumferential direction of the inner circumferential surface of the middle housing 130 adjacent to the outer diameter of the weld coil 42 via the front distribution flow path 420. The distributed oil is sprayed onto the outer diameter of the weld coil 42 through the front spray holes 451 of the front spray ring 450 covering the front distribution flow path 420, thereby cooling the heated weld coil 42.

The end coil cooling system of the present invention, with the above configuration, is advantageous in improving the cooling performance of the end coils by delivering oil evenly across them through a configuration capable of spraying oil toward the outer diameter side for cooling.

The end coil cooling system of the present invention is also advantageous in reducing costs and increasing space utilization by occupying less space, through improved assemblability compared to the conventional O-shaped pipe, achieved by forming a flow path via housing machining and configuring a simple oil spray ring to be coupled to the housing flow path for oil injection.

The end coil cooling system of the present invention is also advantageous in simplifying the manufacturing process and further reducing costs by eliminating the need for a deflector through the formation of the flow path on the housing.

The technical scope of the present invention should not be interpreted as being limited to the above-described embodiments. Various modifications are possible within the scope of the invention claimed in the claims, and those skilled in the art may implement diverse variations without departing from the gist of the present invention. Therefore, such modifications and changes, as long as they are obvious to those skilled in the art, are intended to fall within the scope of the present invention.

### DESCRIPTION OF REFERENCE NUMERALS

1000: cooling system
20: rotor core
30: stator
40: coil
41: crown coil
42: weld coil
100: housing
110: end cover
120: main housing
130: middle housing
200: main flow path
310: end supply flow path
320: end distribution flow path
350: end spray ring
351: end spray hole
410: front supply flow path
420: front distribution flow path
450: front spray ring
451: front spray hole

What is claimed is:

1. An end coil cooling system for a motor, configured to cool axial one-side and opposite-side end coils of coils wound on a stator, disposed on a housing accommodating the stator and a rotor core, the end coil cooling system comprises:
a main flow path disposed along an axial direction of the housing and supplying an oil for cooling the end coils; and
one or more supply flow paths disposed along a radial direction of the housing, an upstream end of each supply flow path being in fluidical communication with the main flow path, and a downstream end of each supply flow path penetrating an inner circumferential surface of the housing to supply the oil from the main flow path to the end coils.

2. The end coil cooling system of claim 1, further comprising:
a distribution flow path disposed along a circumferential direction of the housing, recessed radially inwardly, a bottom surface of the distribution flow path being in fluidical communication with the one or more supply flow paths to distribute the oil in the circumferential direction; and
a spray ring sealing a radially inwardly open surface of the distribution flow path and having one or more spray holes disposed therein to spray the oil onto an outer diameter of the end coils.

3. The end coil cooling system of claim 2, wherein the distribution flow path is disposed in the axial direction on the housing to spray the oil to spray the oil onto portions of the end coil where the coil is exposed.

4. The end coil cooling system of claim 2, wherein the spray ring is coupled to the distribution flow path by hot pressing during a hot pressing process of the stator.

5. The end coil cooling system of claim 2, wherein the one or more spray holes are disposed as a plurality along the circumferential direction and are offset to a first side or a second side of the one or more supply flow paths in the circumferential direction, rather than being aligned with the one or more supply flow paths.

6. The end coil cooling system of claim 2, wherein the distribution flow path has a width, a height, or both the width and the height that decrease with increasing distance from the one or more supply flow paths along the circumferential direction.

7. The end coil cooling system of claim 2, wherein the one or more supply flow paths comprises an end supply flow path adjacent to a crown coil disposed on one axial side of the end coils and a front supply flow path adjacent to a weld coil disposed on the opposite axial side.

8. The end coil cooling system of claim 7,
wherein the distribution flow path comprises an end distribution flow path in fluidical communication with the end supply flow path and a front distribution flow path in fluidical communication with the front supply flow path, and
wherein the spray ring comprises an end spray ring coupled to the end distribution flow path to spray the oil onto the crown coil and a front spray ring coupled to the front distribution flow path to spray the oil onto the weld coil.

9. The end coil cooling system of claim 5, wherein, with respect to the circumferential direction, a first distance between a spray hole disposed on one side of the one or more supply flow paths and the one or more supply flow paths and a second distance between a spray hole disposed on the opposite side of the one or more supply flow paths and the one or more supply flow paths among the one or more spray holes are equal.

10. The end coil cooling system of claim 5, wherein the plurality of spray holes have a spacing that decreases or a diameter that increases as the distance from the one or more supply flow paths along the circumferential direction increases.
